(19) United States
(12) Patent Application Publication
(10) Pub. No.: US 2009/0212456 A1
(43) Pub. Date: Aug. 27, 2009

(54) Apparatus for Imparting Indentations in a Slug from Which Simulated Green Tumbled Bricks Are Formed

(76) Inventor: Jack C. Smale, Victoria (AU)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 11/885,033

(22) PCT Filed: Feb. 24, 2006
(86) PCT No.: PCT/AU06/00235

§ 371 Date: Oct. 7, 2008

(30) Foreign Application Priority Data
Feb. 25, 2005 (AU) 2005900887

(51) Int. Cl. B28B 11/14; B29C 59/00

(52) U.S. Cl. 264/157; 425/161; 425/142

(57) ABSTRACT

An apparatus for imparting indentations in a slug from which green bricks are formed. The slug is elongate about a longitudinal axis and rectangular in transverse cross section to thereby provide a first and second side face extending parallel to the longitudinal axis, a top face and a bottom face. The first and second side face intersect with the top face at a first and second edge, respectively. The apparatus includes a conveyance assembly for conveying the slug in a working direction parallel to the longitudinal axis, and a first and second indentation assembly, adjacent to the conveyance assembly for imparting indentations to the first and second edge of the slug, respectively. The apparatus further includes a third indentation assembly for imparting indentations to the top face of the slug; and control means for controlling operation of the conveyance assembly and the first, second and third indentation assembly. The indentations imparted to the top face of the slug are aligned with the indentations imparted to the first and second edge.

### FIELD OF THE INVENTION

The present invention relates to an apparatus for manufacturing bricks. More specifically, the present invention relates to an apparatus for imparting indentations in a slug from which green bricks, that simulate the appearance of green tumbled bricks, are formed. The present invention further relates to a method of imparting indentations using the apparatus.

### BACKGROUND OF THE INVENTION

The manufacturing process of a brick commences with the extrusion of a clay mixture through an extrusion device to form a horizontally extending clay column having a generally rectangular cross section. The column is then cut into lengths called slugs. During the latter stages of the brick manufacturing process the slugs are cut into individual bricks of common dimensions by passing them through a cutting device such as a push through cutter.

A green brick is typically referred to as being a brick which having left the extrusion device as part of a slug has subsequently been cut into an individual brick of common dimension. Whereas, a fired brick is a green brick which has passed through a kiln and subsequently been fired.

Attempts have been made in the past to produce bricks which have an irregular appearance by deforming the edge surfaces of each brick to provide a unique appearance. Prior to being fired these bricks are often referred to as green tumbled bricks. Typically the unique appearance is imparted to the bricks by a process whereby green bricks are dropped and allowed to tumble down an inclined surface to impart indentations to the edges of each brick. Alternatively, the green bricks can be placed into a tumbling drum which rotates to tumble the bricks and subsequently impart indentations to each brick. A problem with both of these approaches is that once the tumbling process is completed the bricks are randomly orientated and need to be manually handled and stacked uniformly so that they can be placed on a kiln car for subsequent placement into a kiln for firing. This process is extremely labour intensive, repetitive and time consuming which accordingly results in tumbled bricks being costly to manufacture.

In Australian Innovation Patent No. 2003100258 entitled “Equipment for the simulation of a green tumbled brick” an apparatus and method of producing simulated green tumbled bricks is disclosed wherein a slug is placed on a conveyor belt and passed between a pair of rotating and deforming wheel assemblies to deform edges of the slug. A problem with the apparatus disclosed in the Innovation Patent is that when the slug is cut into individual bricks the longitudinal edges of the brick created by the cutting of the slug are not deformed. Consequently, the bricks produced only partially have the appearance of green tumbled bricks.

Accordingly, it would be desirable to provide an apparatus which overcomes or ameliorates at least one of the above mentioned problems associated with producing green tumbled bricks.

Any discussion of documents, devices, acts or knowledge in this specification is included to explain the context of the invention. It should not be taken as an admission that any of the material formed part of the prior art base or the common general knowledge in the relevant art in Australia or other countries on or before the priority date of the claims herein.

### SUMMARY OF THE INVENTION

In accordance with a first aspect of the present invention there is provided an apparatus for imparting indentations in a slug from which green bricks are formed. The slug is elongate about a longitudinal axis and rectangular in transverse cross section to thereby provide a first and second side face extending parallel to the longitudinal axis, a top face and a bottom face. The first and second side face intersect with the top face at a first and second edge, respectively. The apparatus includes a conveyance assembly for conveying the slug in a working direction parallel to the longitudinal axis, and a first and second indentation assembly adjacent to the conveyance assembly for imparting indentations to the first and second edge of the slug, respectively. The apparatus further includes a third indentation assembly for imparting indentations to the top face of the slug; and control means for controlling operation of the conveyance assembly and the first, second and third indentation assembly.

Preferably, in use, the third indentation assembly imparts spaced indentations to the top face of the slug which each align with corresponding spaced indentations formed in the first and second edge by the first and second indentation assembly, respectively.

Preferably, the third indentation assembly is located downstream of the first and second indentation assembly in the working direction. At least one of the indentations imparted to the top face by the third indentation assembly preferably adjoins with a corresponding indentation formed in the first or second edge. In addition, the indentations imparted to the top face by the third indentation assembly preferably transverse the top face substantially perpendicular to the longitudinal axis.

The first and second indentation assemblies may be located adjacent to the first and second side face, respectively, of the slug and may also impart spaced indentations to the first and second side face, respectively of the slug. These indentations preferably each align and/or adjoin with the corresponding spaced indentations formed in the first and second edge.

The first and second side face of the slug also intersects with the bottom face of the slug at a third and fourth edge, respectively. The first and second indentation assemblies may also impart spaced indentations to the third and fourth edge, respectively, which each align and/or adjoin with a corresponding spaced indentation formed in the first and second edge and/or the first and second side face. Further, each spaced indentation imparted to the first and second side face advantageously extends between the top face and the bottom face substantially perpendicular to the longitudinal axis.

In a particularly preferred embodiment, the first and second indentation assemblies each include an indentation wheel rotatable about a vertical axis. Each indentation wheel preferably includes an upper and lower rotatable member having a plurality of indentation tools mounted thereon for engagement with the slug to thereby impart indentations.

Preferably, the indentation tools of the upper rotatable member on the first indentation assembly are engageable with the first edge and/or first side face of the slug, and the indentation tools of the lower rotatable member of the first indentation assembly are engageable with the third edge and/or first side face. In addition, the indentation tools of the upper rotatable member on the second indentation assembly are engageable with the second edge and/or second side face of the slug, and the indentation tools of the lower rotatable member of the second indentation assembly are engageable with the fourth edge and/or second side face.

The position of the indentation tools of the upper and lower rotatable member of the first indentation assembly may be adjusted to thereby alter the appearance of the indentations formed on the slug by the first indentation assembly. Similarly, the position of the indentation tools of the upper and lower rotatable member of the second indentation assembly may be adjusted to thereby alter the appearance of the indentations formed on the slug by the second indentation assembly.

In accordance with a particularly preferred embodiment, the third indentation assembly includes an indentation roller rotatable about a horizontal axis perpendicular to the longitudinal axis of the slug. The indentation roller includes a plurality of indentation bars which extend parallel to the axis of the indentation roller and are engageable with the top face of the slug to impart the indentations to the top face. Further, the position of the indentation bars of the third indentation assembly may be adjusted to thereby alter the appearance of the indentations formed on the top face of the slug.

In addition, the indentation tools of the first and second indentation assemblies and the indentation bars of the third indentation assembly may each be shaped differently such that the indentations imparted vary in appearance.

In accordance with a preferred embodiment a wire bank is located downstream of the third indentation assembly in the working direction for cutting the slug into greens bricks. Preferably, the wire bank includes a cutter for cutting the slug into green bricks and the positioning of the cutter with respect to the slug is controlled by the control means such that the cutter cuts the slug only where the spaced indentations in the top face of the slug are located. In this regard it is preferable that the cutter cut the slugs at a mid-point in each indentation formed in the top face.

In accordance with a further aspect of the present invention there is provided a method of imparting indentations in a slug from which green bricks are formed. The slug is elongate about a longitudinal axis and rectangular in transverse cross section to thereby provide a first and second side face extending parallel to the longitudinal axis, a top face and a bottom face. The first and second side face intersecting with the top face at a first and second edge, respectively. The method includes conveying the slug in a working direction parallel to the longitudinal axis via a conveyance assembly. Imparting spaced indentations to the first and second edge of the slug via a first and second indentation assembly located adjacent to the conveyance assembly. Imparting spaced indentations to the top face of the slug via a third indentation assembly and controlling operation of the conveyance assembly and the first, second and third indentation assembly via a control means.

Preferably, one or more of the spaced indentations imparted to the top face of the slug by the third indention assembly each align and/or adjoin with a corresponding spaced indentation formed in the first and second edge.

### BRIEF DESCRIPTION OF THE DRAWINGS

Further benefits and advantages of the present invention will become apparent from the following description of the preferred embodiment of the invention. The preferred embodiment should not be considered as limiting any of the statements in the previous section. The preferred embodiment will be described with reference to the following figures in which:

FIG. 1 is a perspective view of the apparatus according to an embodiment of the invention, having a slug about to be imparted with indentations mounted thereon

FIG. 2 is a perspective view of the apparatus shown in FIG. 1, illustrating a slug after being imparted with indentations.

FIG. 2a is a partial end view of the apparatus shown in FIG. 1, illustrating a slug exiting from the first and second indentation assemblies.

FIG. 3a is a perspective view of a slug having passed through the first and second indentation assemblies prior to engagement with the third indentation assembly.

FIG. 3b is a perspective view of a slug following interaction with the third indentation assembly prior to the slug being cut into green bricks.

FIG. 3c in a side view of the slug shown in FIG. 3b.

FIG. 3d is a side view of the slug shown in FIG. 3b following the slug being cut into individual green bricks.

### DESCRIPTION OF PREFERRED EMBODIMENT

With reference to the accompanying drawings there is shown an apparatus 1 for imparting indentations in a slug 3 from which green bricks are formed. The slug 3 is generally elongate about a longitudinal axis and rectangular in traverse cross section to thereby provide a first and second side face 5, 7 extending parallel to the longitudinal axis of the slug 3, a top face 9 and a bottom face 11. The first and second side face 5, 7 intersect with the top face 9 at a first and second edge 13, 15. The first and second side face 5, 7 of the slug 3 also intersect with the bottom face 11 at a third and fourth edge 17, 19, respectively.

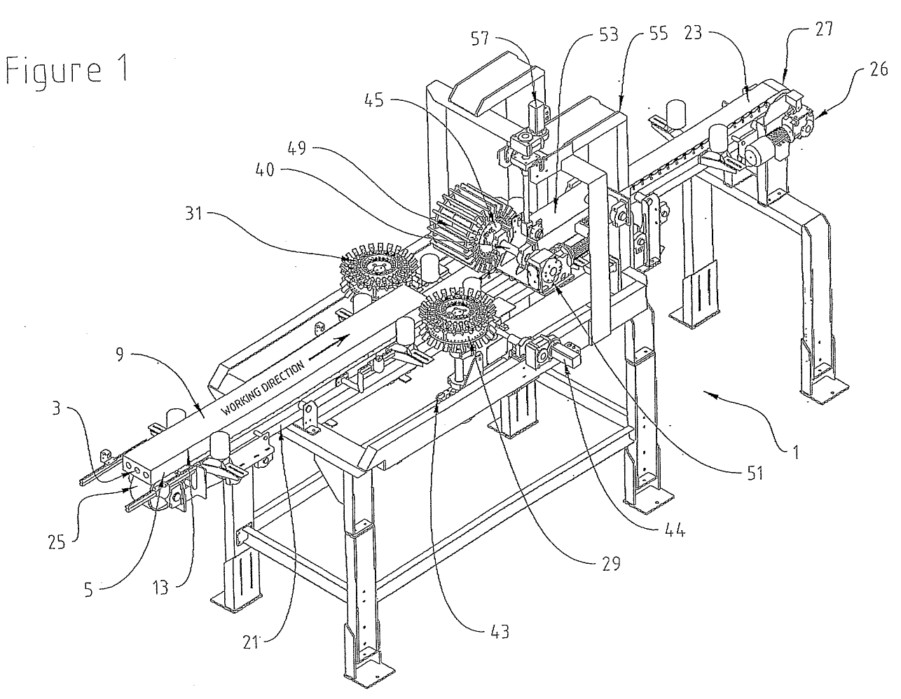

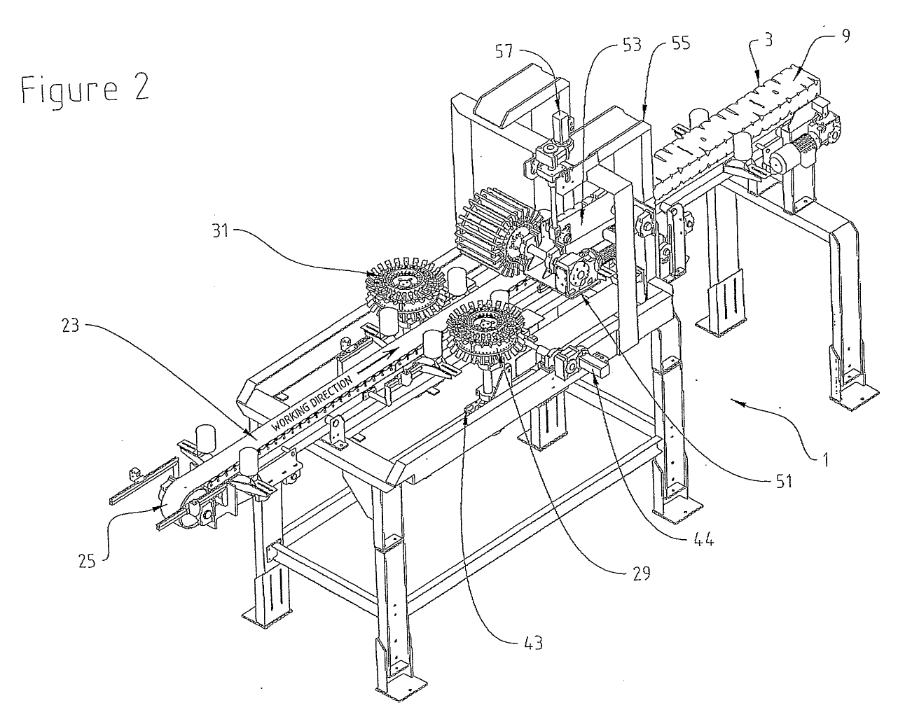

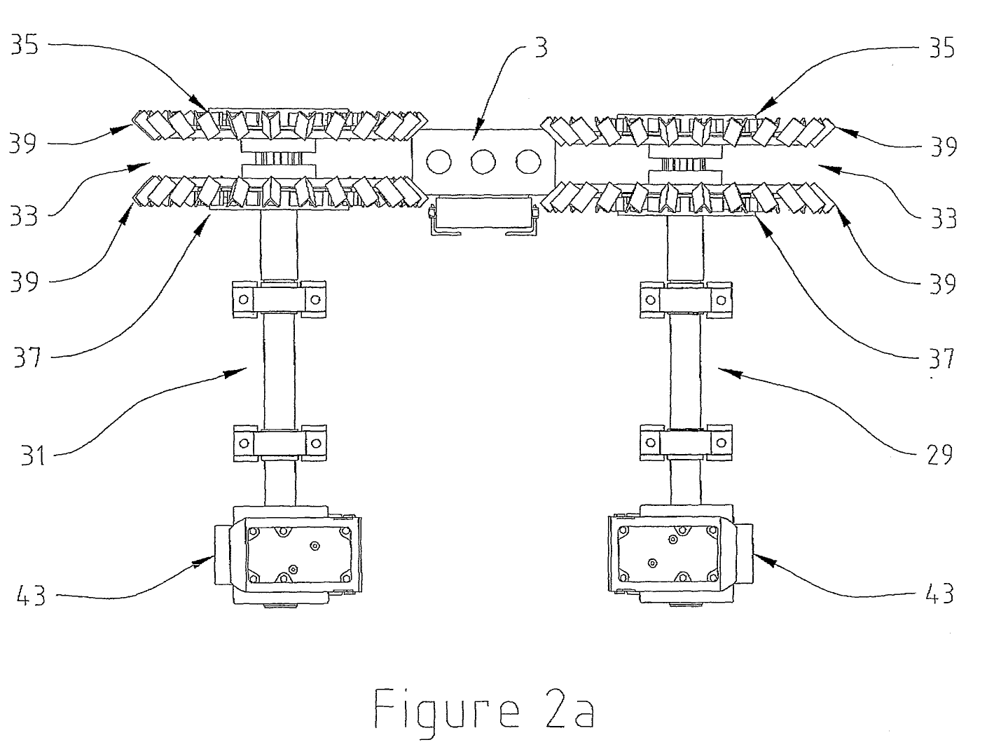

The apparatus 1 includes a conveyance assembly 21 for conveying the slug 3 in a working direction, as indicated in FIGS. 1 and 2, which is parallel to the longitudinal axis of the slug 3. The conveyance assembly 21 extends the length of the apparatus 1 and consists of a conveyor belt 23 along which the slug 3 is transported. The apparatus 1 has an upstream end 25 and a downstream end 27. The conveyance assembly 21 further includes a conveyor motor 26 for driving the conveyor belt 23 via a conveyor drive shaft.

The apparatus 1 further includes a first and second indentation assembly 29, 31. The first indentation assembly 29 is located to the right hand side of the conveyor belt 23 when viewed from the upstream end 25, whilst the second indentation assembly 31 is located adjacent to the left hand side of the conveyor belt 23. The first and second indentation assemblies 29, 31 are each equally distanced from the upstream end 25 and each include an indentation wheel 33 which is rotatable about a vertical axis. The indentation wheel 33 includes an upper and lower rotatable member 35, 37 with each rotatable member having a plurality of indentation tools 39 mounted thereon for engagement with the slug 3. The indentation tools 39 are adjustable in position to thereby vary the angle of impact each tool 39 makes with the slug 3. Further, the indentation tools 39 are interchangeable and each shaped differently so that the indentations formed on the slug 3 are not all the same. Instead of removing and replacing individual indentation tools 39 the entire rotatable member 35, 37 can instead be replaced.

The first and second indentation assemblies 29, 31 also each include a primary and secondary geared motor 43, 44. Each primary geared motor 43 is operatively connected to an associated indentation wheel 33 to impart rotational movement to the rotatable members 35, 37. Each secondary geared motor 44 is operatively connected to an associated indentation wheel 33 to impart lateral movement to the indentation wheel 33. Accordingly the indentation wheels 33 of the first and second indentation assemblies 29, 31 can be independently moved towards and away from each other to adjust the spacing therebetween. In this regard the spacing between the indentation wheels 33 is typically adjusted to accommodate slugs 3 of varying width and also adjust the depth of the indentations to be imparted by the indentation tools 39. It should be noted that the spacing between the indentation wheels 33 remains fixed when indentations are being imparted to the slug 3.

The apparatus 1 further includes a third indentation assembly 45 for selectively imparting indentations to the top face 9 of the slug 3. The third indentation assembly 45 is located downstream of the first and second indentation assemblies 29, 31 in the working direction, as indicated in FIG. 1. The third indentation assembly 45 includes an indentation roller 47 which is rotatable about a horizontal drive axis 49 that is perpendicular to the working direction. The indentation roller 47 includes a plurality of indentation bars 40 which extend parallel to the horizontal axis 49 of the indentation roller 47. The indentation bars 40 of the indentation roller 47 are significantly different to the indentation tools 39 of the first and second indentation assemblies 29, 31 in that they are shaped to impart substantially elongate indentations to at least a portion of the top face 9 of the slug 3. Each indentation bar 40 is of a slightly different shape such that the indentations imparted by the indentation bars 40 vary in appearance.

The third indentation assembly 45 further includes a first and second geared motor 51, 57. The first geared motor 51 is connected to an end of the horizontal drive axis 49 to operatively impart rotational motion to the indentation roller 47. The third indentation assembly 45 further includes a support arm 53 pivotally mounted to a main frame 55 of the apparatus 1. Connected to the support arm 53 and the main frame 55 is the second geared motor 57 for adjusting the vertical positioning of the indentation roller 47 with respect to the slug 3 and accordingly the depth of indentations to be imparted by the indentation roller 47. It should be noted that the vertical position of the indentation roller 47 with respect to the slug 3 remains fixed when indentations are being imparted to the slug 3.

To control the positioning of the indentations imparted to the slug 3 by the first, second and third indentation assemblies a control means is provided. The control means includes a programmable logic controller (PLC) having an operator interface. The control means monitors the speed of the conveyor belt 23, monitors and controls the position and speed of rotation of each indentation wheel 33, and the speed and position of the indentation roller 47. The control means responds to sensed signals and provides control signals to AC frequency positioning inverters associated with the primary and secondary geared motors 43, 44 of the first and second indentation assemblies 29, 31, the first and second geared motors 51, 57 of the third indentation assembly 45, and the conveyor motor 26.

The control signals provided by the control means ensure that the indentations imparted to the top face 9 of the slug 3 by the indentation roller 47 each align with the indentations imparted to the slug 3 by the first and second indentation assemblies 29, 31. In this regard, the control means ensures that the circumferential speed of each indentation wheel 33 and the indentation roller 47 are synchronised with the speed of the conveyor belt 23. In this respect, the AC frequency positioning inverters associated with the primary geared motors 43 of the first and second indentation assemblies 29, 31 and the first geared motor 51 are connected to a master encoder associated with the conveyor drive shaft of the conveyor motor 26. The master encoder counts pulses as the conveyor drive shaft rotates to accurately measure the speed of the conveyor belt 23. Based upon the measured speed of the conveyor belt 23, the primary geared motors 43 of the first and second indentation assemblies 29, 31 and the first geared motor 51 of the third indentation assembly 45 are provided with the appropriate control signals by the control means such that the circumferential speed of each indentation wheel 33 and the indentation roller 47 is synchronised with the speed of the conveyor belt 23.

In order to increase the depth of indentations the indentations wheels 33 and indentation roller 47 can individually be positioned closer to the slug 3 via the operator interface prior to imparting rotational movement to the rotatable members 35, 37. However as the depth of indentations required is increased the circumference of the indentation wheel/roller is effectively reduced at the surface of the slug 3. Accordingly, the circumferential speed of one or more of the indentation wheels/roller 33, 47 may need to be slightly adjusted via the control means such that the indentation wheels/roller 33, 47 remain synchronised with the speed of the conveyor belt 23.

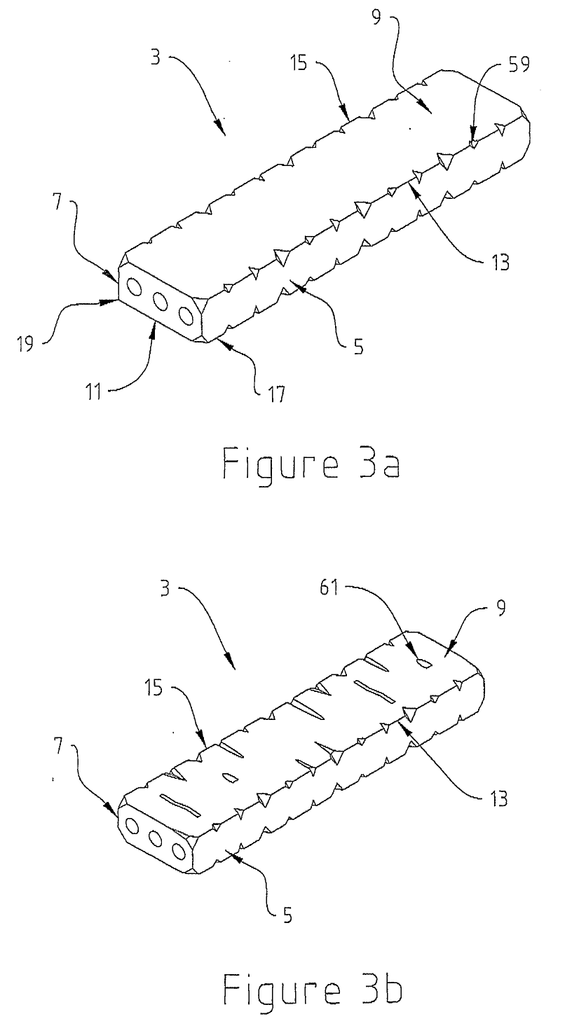

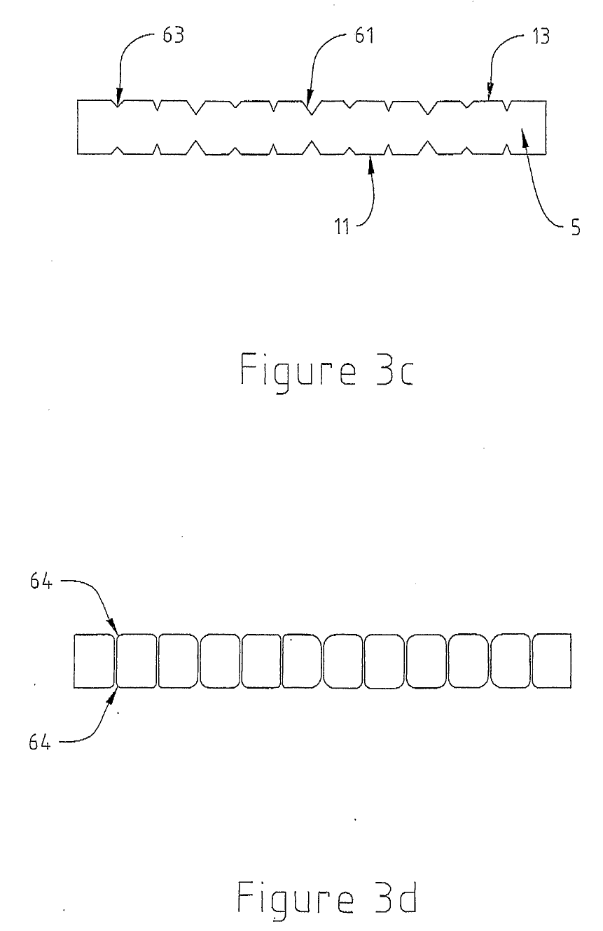

With reference to FIG. 3a there is shown a slug 3 after having been imparted with indentations by the first and second indentation assemblies 29, 31, prior to interaction with the third indentation assembly 45. The indentations 59 imparted to the slug 3 by the first and second indentation assemblies 29, 31 are generally V-shaped in cross section and can be increased in width and length by adjusting the positioning of the indentation tools 39 of the upper and lower rotatable members 35, 37. For example, by increasing the width of the indentation tools 39 the width of the indentations imparted in the direction of the longitudinal axis of slug 3 can be increased such that the indentations imparted to each edge 13, 15, 17, 19 of the slug can be virtually adjoined to thereby leave no portion of each edge unaffected by the indentations tools 39. Similarly, the length of the indentations imparted to each edge 13, 15, 17, 19 of the slug 3 can be increased such that the indentations imparted to the first edge 13 adjoin with the indentations imparted to the third edge 17, and likewise for the indentations imparted to the second edge 15 and the fourth edge 19.

With reference to FIGS. 2 and 3b there is shown the slug 3 immediately following interaction with all three indentation assemblies 29, 31, 45. The indentations 61 imparted to the top face 9 of the slug 3 by the indentation roller 47 of the third indentation assembly 45 align with corresponding indentations 59 imparted to the first edge 13 and the second edge 15. Further, some of the indentions 61 imparted to the top face 9 by the indentation roller 47 adjoin with indentations imparted to the first or second edge 13, 15.

The downstream end 27 of the conveyor belt 23 can be provided with a wire bank (not illustrated in the drawings) for cutting the slug into green bricks. In this regard, the positioning and operation of the cutter with respect to the slug 3 can be controlled by the control means such that the cutter cuts the slug 3 to create green bricks by ensuring that a cutting edge of the cutter cuts the slug along the centre 63 of each indentation 61 formed in the top face 9 and indentations formed in the first and second edge 13, 15. With reference to FIG. 3d, this ensures that the resultant green bricks produced have edges 64 adjacent to the cut which appear rounded to provide the appearance of a tumbled green brick.

In operation, the slug 3 is placed on the conveyor belt 23 at the upstream end 25. It is then determined by an operator as to whether the positioning of the indentation wheels 33 and indentation roller 47 is suitable for the size of the slug 3 and the depth of indentations required. Should the positioning of an indentation wheel/roller need to be adjusted, the control means is operated to send a control signal to the appropriate secondary geared motor 43, 44 of the first and second indentation assembly 29, 31, or second geared motor 57 of the third indentation assembly 45. Once the indentation wheels 33 and indentation roller 47 are in the appropriate position the control means is operated to signal the conveyor motor 26 to commence operation. As the slug 3 is transported along the conveyor belt 23 in the working direction a first photoelectric cell mounted on the conveyance assembly 21, prior to the first and second indentation assemblies 29, 31, sends a signal to the control means when the position of the slug 3 on the conveyor belt 23 is detected. The control means then sends a control signal to each primary and secondary geared motor 43, 44 such that the indentation wheels 33 have time to gather momentum and reach a circumferential speed corresponding with the speed of the conveyor belt 23 prior to the engagement of the indentation tools 39 with the slug 3. In addition the control means sends a control signal to the first and second geared motors 51, 57 of the third indentation assembly 45 such that the indention roller 47 has time to gather momentum and reach a circumferential speed corresponding with the speed of the conveyor belt 23 prior to the engagement of the indentation bars 40 with the slug 3. Following the slugs 3 interaction with the first, second and third indentation assemblies 29, 31, 45 a second photoelectric cell mounted on the conveyance assembly 21, downstream of the third indentation assembly 45, sends a signal to the control means when the passing of the slug 3 is detected. The control means subsequently provides a control signal to each geared motor which stops the rotation of the indentation wheels 33 and indentation roller 47. Prior to the arrival of the next slug 3 the control signal sends a control signal to one of the primary geared motors 43 such that the associated indentation wheel 33 is rotated by an amount equal to the spacing between adjacent indentation tools 39. This ensures that the next slug 3 is not imparted with exactly the same arrangement of indentations as the previous slug 3.

The present invention advantageously provides a means by which indentations can be suitably imparted to a slug 3, such that green bricks which are subsequently produced after the slug 3 is cut, have the simulated appearance of a tumbled green bricks. Further the present invention can be integrated into existing brick manufacturing processes without requiring the labour intensive manual handling of the bricks as is required with conventional tumbled green brick production.

As the present invention may be embodied in several forms without departing from the essential characteristics of the invention, it should be understood that the above described embodiment should not be considered to limit the present invention but rather should be construed boldly. Various modification and equivalent arrangements are intended to be included within the spirit and scope of the invention.

1. An apparatus for imparting indentations in a slug from which green bricks are formed, said slug being elongate about a longitudinal axis and rectangular in transverse cross section to thereby provide a first and second side face extending parallel to the longitudinal axis, a top face and a bottom face; the first and second side face intersecting with the top face at a first and second edge, respectively; said apparatus including:
a conveyance assembly for conveying the slug in a working direction parallel to the longitudinal axis;
a first and second indentation assembly adjacent to the conveyance assembly for imparting indentations to the first and second edge of the slug, respectively;
a third indentation assembly for imparting indentations to the top face of the slug; and
a control means for controlling operation of the conveyance assembly and the first, second and third indentation assembly, wherein, in use, the third indentation assembly imparts at least one indentation to the top face of the slug which aligns with a corresponding indentation in the first and second edge.

2. An apparatus as claimed in claim 1 wherein, in use, the third indentation assembly imparts spaced indentations to the top face of the slug which each align with corresponding spaced indentations formed in the first and second edge by the first and second indentation assembly, respectively.

3. An apparatus as claimed in claim 2 wherein the third indentation assembly is located downstream of the first and second indentation assemblies in the working direction.

4. An apparatus as claimed in claim 3 wherein at least one of the indentations imparted to the top face by the third indentation assembly adjoins with a corresponding indentation formed in the first or second edge.

5. An apparatus as claimed in claim 1 wherein indentations imparted to the top face by the third indentation assembly transverse the top face substantially perpendicular to the longitudinal axis.

6. An apparatus as claimed in claim 4 wherein the first and second side face of the slug intersect with the bottom face of the slug at a third and fourth edge, respectively, and wherein the first and second indentation assemblies further impart spaced indentations to the third and fourth edge, respectively which each align with the corresponding spaced indentations formed in the first and second edge.

7. An apparatus as claimed in claim 1 wherein the first and second indentation assemblies each include an indentation wheel rotatable about a vertical axis.

8. An apparatus as claimed in claim 7, wherein each indentation wheel includes an upper and lower rotatable member each having a plurality of indentation tools mounted thereon for engagement with the slug to thereby impart indentations.

9. An apparatus as claimed in claim 8 wherein the indentation tools of the upper rotatable member on the first indentation assembly are engageable with the first edge of the slug, and the indentation tools of the lower rotatable member of the first indentation assembly is engageable with the third edge.

10. An apparatus as claimed in claim 8 wherein the indentation tools of the upper rotatable member on the second indentation assembly are engageable with the second edge of the slug, and the indentation tools of the lower rotatable member of the second indentation assembly are engageable with the fourth edge.

11. An apparatus as claimed in claim 9, wherein the position of the indentation tools of the upper and lower rotatable member of the first indentation assembly are adjustable to thereby alter the appearance of the indentations formed on the slug by the first indentation assembly.

12. An apparatus as claimed in claim 10, wherein the position of the indentation tools of the upper and lower rotatable member of the second indentation assembly are adjustable to thereby alter the appearance of the indentations formed on the slug by the second indentation assembly.

13. An apparatus as claimed in claim 1 wherein the third indentation assembly includes an indentation roller rotatable about a horizontal axis perpendicular to the longitudinal axis of the slug.

14. An apparatus as claimed in claim 13 wherein the indentation roller includes a plurality of indentation bars which extend parallel to the axis of the indentation roller and are engageable with the top face of the slug to impart the indentations to the top face.

15. An apparatus as claimed in claim 14 wherein the position of the indentation bars of the third indentation assembly are adjustable to thereby alter the appearance of the indentations formed on the top face of the slug.

16. An apparatus as claimed in claim 1 wherein the indentation tools of the first and second assemblies are each shaped differently such that the indentations imparted by the tools vary in appearance.

17. An apparatus as claimed in claim 1 wherein the indentation bars are each shaped differently such that the indentations imparted by the bars vary in appearance.

18. A device for manufacturing green bricks from a slug which is elongate about a longitudinal axis and rectangular in transverse cross section to thereby provide a first and second side face extending parallel to the longitudinal axis, a top face and a bottom face; the first and second side face intersecting with the top face at a first and second edge, respectively; said device including:
an apparatus as claimed in any one of the preceding claims, and
a wire bank located downstream of the third indentation assembly in the working direction for cutting the slug into greens bricks.

19. A device as claimed in claim 18 wherein the wire bank includes a cutter for cutting the slug into green bricks, the positioning of the cutter with respect to the slug being controlled by the control means such that the cutter cuts the slug only where the spaced indentations in the top face of the slug are located.

20. A method of imparting indentations in a slug from which green bricks are formed, said slug being elongate about a longitudinal axis and rectangular in transverse cross section to thereby provide a first and second side face extending parallel to the longitudinal axis, top face and a bottom face; the first and second side face intersecting with the top face at a first and second edge, respectively; said method including:
conveying the slug in a working direction parallel to the longitudinal axis via a conveyance assembly; and
imparting spaced indentations to the first and second edge of the slug via a first and second indentation assembly located adjacent to the conveyance assembly; and
imparting spaced indentations to the top face of the slug via a third indentation assembly; and
controlling operation of the conveyance assembly and the first, second and third indentation assembly via a control means.

21. A method as claimed in claim 20 wherein one or more of the spaced indentations imparted to the top face of the slug by the third indention assembly each align with a corresponding spaced indentation formed in the first and second edge.

22. A method of forming green bricks from a slug which is elongate about a longitudinal axis and rectangular in transverse cross section to thereby provide a first and second side face extending parallel to the longitudinal axis, a top face and a bottom face; the first and second side face intersecting with the top face at a first and second edge, respectively; said method including:
imparting spaced indentations in the slug in accordance with the method of claim 20 or 21 (a) or (b) as follows:
(a) conveying the slug in a working direction parallel to the longitudinal axis via a conveyance assembly; and
imparting spaced indentations to the first and second edge of the slug via a first and second indentation assembly located adjacent to the conveyance assembly; and
imparting spaced indentations to the top face of the slug via a third indentation assembly; and
controlling operation of the conveyance assembly and the first, second and third indentation assembly via a control means;
(b) conveying the slug in a working direction parallel to the longitudinal axis via a conveyance assembly; and
imparting spaced indentations to the first and second edge of the slug via a first and second indentation assembly located adjacent to the conveyance assembly; and
imparting spaced indentations to the top face of the slug via a third indentation assembly; and
controlling operation of the conveyance assembly and the first, second and third indentation assembly via a control means, wherein one or more of the spaced indentations imparted to the top face of the slug by the third indention assembly each align with a corresponding spaced indentation formed in the first and second edge; and
controlling the positioning of a cutter with respect to the slug via the control means, and cutting along the spaced indentations in the top face of the slug to thereby form green bricks.

23. (canceled)

24. (canceled)

25. (canceled)

26. (canceled)

27. An apparatus as claimed in claim 5 wherein the first and second side face of the slug intersect with the bottom face of the slug at a third and fourth edge, respectively, and wherein the first and second indentation assemblies further impart spaced indentations to the third and fourth edge, respectively which each align with the corresponding spaced indentations formed in the first and second edge.
